(19) United States
(12) Patent Application Publication
(10) Pub. No.: US 2016/0257821 A1
(43) Pub. Date: Sep. 8, 2016

(54) BINDING DISPERSION FOR THE PRODUCTION OF INSECTICIDE PAINTS AND METHOD FOR PRODUCING SAID DISPERSION

(71) Applicant: INDUSTRIAS KOLMER, S.A., Albolote (Granada) (ES)

(72) Inventor: Angel RUIZ CONTRERAS, Granada (ES)

(21) Appl. No.: 14/898,738

(22) PCT Filed: Apr. 14, 2014
(86) PCT No.: PCT/ES2014/070307

§ 371 Date: Dec. 15, 2015

(30) Foreign Application Priority Data
Apr. 15, 2013 (ES) P201330534

(51) Int. Cl. C09D 5/14; A01N 43/40; A01N 25/10; A01N 53/00

(52) U.S. Cl. CPC C09D 5/14; A01N 53/00; A01N 43/40; A01N 25/10

(57) ABSTRACT

The invention relates to a binding dispersion for the production of insecticide paints and to a method for producing said dispersion, consisting of an aqueous dispersion of modified VeoVa vinyl nature, including active biocide materials, in which the polymer is vinyl acetate and VeoVa and the biocide materials, at a concentration of 10%, are immersed to surround the polymer particles, forming a structure with a polymer core and a shell of active ingredients. The production method comprises: a seeding step, in which a small part of the pre-emulsion (monomers, emulsifiers, water) and catalyst is added to the reactor; a polymerization step, in which the rest of the catalyst and pre-emulsion is then added, followed by the active biocide materials; stirring at high temperatures for at least one hour; and a redox reaction, with oxidizing and reducing agents.

### OBJECT OF THE INVENTION

As expressed in the title of the present specification, the invention relates to a binding dispersion for the production of insecticide paints and to the method for producing said dispersion, providing for the function for which it is intended innovative advantages and features that will be described in detail below and that entail a striking novelty in its field of application.

More particularly, the object of the invention relates to an a aqueous dispersion of modified VeoVa vinyl nature, including active biocide materials, which is particularly applicable and advantageous for the production of any type of insecticide paints, because as a result of said constitution the insecticide paints produced with this biocide dispersion gradually release these active materials, so the persistence of the action over time is considerably greater than in other in other types of insecticides, and furthermore, due to this gradual release, the toxicity of these paints is considerably lower.

Another enormous advantage provided by this dispersion is the possibility of making insecticide paints from it, using it as a binder, without the manufacturer (operators) having to come into contact with the active ingredients since they are already included in the dispersion.

In turn, a second aspect of the invention refers to a method for producing the dispersion, which is produced by means of polymerization in emulsion, with excellent features for formulating insecticide paints both for indoors and outdoors.

### FIELD OF APPLICATION OF THE INVENTION

The field of application of the present invention is comprised within the sector of the chemical industry, particularly focusing on the field of the industry dedicated to the production of paints, and more specifically paints with insecticide effects.

### BACKGROUND OF THE INVENTION

The production of insecticide paints which, as is known, help to prevent the proliferation of insects in homes, buildings, and any type of surface on which they are applied, is known.

Such paints are particularly effective in developing countries in which there are no resources for other types of prevention, such as widespread vaccines, and, however, given that they are normally areas with warm and humid climates, it is where more types of insects that cause contagious diseases are concentrated.

The problem is that producing said type of paints with currently known systems is limited to given types of paint, so that the insecticide effect is effective. Furthermore, said effect is rapidly lost. In turn, the processes for producing said paints entail health risks for the operators involved therein, as they must be in direct contact with the substances containing the active biocide ingredients, as they are added to the paint once it is produced.

The objective of the present invention is to therefore achieve preventing said drawbacks by means of developing a binding substance which serves to produce any type of paint, it being the actual said binder that contains the active biocide ingredients determining the insecticide nature of the produced paint.

As a reference to the current state of the art, it should be pointed out that at least the applicant is unaware of the existence of any other binding dispersion for the production of insecticide paints, or an invention having a similar application, which has constitutive features or characteristics of a method for producing similar to those of the dispersion herein proposed, as claimed.

### DESCRIPTION OF THE INVENTION

The binding dispersion for the production of insecticide paints proposed by the present invention is thus a remarkable novelty within its field of application, because as a result of its implementation and specifically the aforementioned objectives are satisfactorily met, the characterizing details making it possible being suitably described in the final claims attached to the present specification thereof.

Specifically, the invention proposes an aqueous dispersion based on a special mixed polymerization with non-polymeric active ingredients forming a unique, high-performance binder, adapted to environmental laws, to be used in producing insecticide paints.

The present invention relates to an aqueous dispersion of modified VeoVa vinyl nature, including active biocide materials, such that insecticide paints produced with this biocide dispersion gradually release these active materials, so the persistence of the action over time is considerably greater than in other types of insecticides, and furthermore, due to this gradual release, the toxicity of these paints is considerably lower.

This binder is produced by means of polymerization in emulsion, with excellent features for formulating insecticide paints both for indoors and outdoors.

It should be pointed out that said paints need to have the internal structure necessary to enable the controlled diffusion of the active biocide ingredients once they are applied, together with a good balance between hardness and elasticity, good resistance to pressure and to fouling, and of course, good performance against ultraviolet radiation and weather stability.

This necessary internal structure is provided by the actual nature of this biocide dispersion of VeoVa vinyl as a result of the type of monomers chosen, the selection of emulsifiers and surfactants and the ester configuration together with the cross-linking achieved after the “coalescence” (cold melting process in which the dry film of paint formed due to dispersion transforms from being a discontinuous molecular structure to a continuous and flexible structure). All this allows producing the pore size suitable for this diffusion of active biocide materials.

The method for producing the dispersion, i.e., polymerization reactions, is carried out in the following steps:
The first step is referred to as seeding, in this part of the reaction a small part of the pre-emulsion (mixture of monomers, emulsifiers, water), with a small amount of catalyst, is added to the reactor. This achieves formation of polymer cores with very similar particle sizes.
The second step of the reaction is polymerization per se. During this step, what is done is that the catalyst and pre-emulsion are added simultaneously so that they may react. When this step concludes, active biocide materials are added. When these active materials are added, they surround the polymer particles formed during the polymerization step, forming a core-shell type structure (i.e., it has a polymer core and a shell formed by active ingredients).
Once the additions have ended, it is left to stir at high temperatures for at least one hour so that the monomer that may remain from the preceding step finishes reacting.
When the preceding step concludes, a redox reaction is performed in which a reducing agent and an oxidizing agent are added, and when these agents react they cause using up also the rest of the monomers that have not yet reacted. As a result of this step, the free monomer of the produced dispersion can be largely reduced.

Based on the foregoing, it can be seen that the described binding dispersion for the production of insecticide paints and the method for producing it are an innovation of constitutive features unknown up until now for the purpose for which it is intended, and these reasons combined with the practical usefulness of the same confer to it sufficient grounds to obtain the exclusive privilege requested.

### DESCRIPTION OF THE DRAWINGS

To complement the description being made and for the purpose of helping to better understand the features of the invention, a set of drawings is attached to the present specification as an integral part thereof, in which the following has been depicted with an illustrative and non-limiting character:

FIG. 1 shows the graph of a comparative chromatogram of two dispersions with different free monomer concentrations.

FIG. 2 shows the production protocol graph of the flow and viscosity curves of the dispersion object of the invention.

FIG. 3 shows the trend graph of the viscoelastic modulus of storage and losses of a sample.

### PREFERRED EMBODIMENT OF THE INVENTION

The method followed and the production protocol and tests performed for the different parameters of the proposed dispersion are described in detail below:

### Glass Transition Temperature Tg

This parameter is important for producing the dispersion and depends on the monomers chosen to form the polymer. The minimum film-forming temperature (MFFT) depends on it, and the use of coalescers that must be used to make the paint depend on the MFFT. The Fox equation is used to adjust the proportions of these monomers.

$$\frac{1}{Tg} = {\sum }_{i = 1}^{n} \frac{{w}_{i}}{{Tg}_{i}}$$

where wᵢ is the mass fraction of the polymer i in the polymer, Tgᵢ is the Tg of the polymer i at absolute temperature.

Taking into account the desired Tg, it is concluded that the monomers of interest to be used are vinyl acetate and VeoVa.

pH

The insecticide active ingredient is immersed in the VeoVa vinyl polymer mass, therefore people handling the product for producing the insecticide paint are isolated from the biocide substances they have to handle, and it is provided a suitable environment for the active ingredients, protecting them from aggressive agents, such as alkalinity, for example, as most insecticides degrade in strongly alkaline media, such as conventional acrylic paints or alkaline substrates (cement, etc.). Also in this case, dispersions of VeoVa vinyl offer advantages because they can be formulated at a slightly acidic pH (4-5), and in addition they have to be robust enough to prevent their destruction during the preparation or application of the paint.

### Free Monomer

One of the controlled parameters is the free monomer concentration, because it must be as low as possible so that the only VOC (volatile organic compound) present is the one provided by the active biocide ingredients.

Gas chromatography is used for the free monomer determination. Two methods were used: an internal control method and another method according to the specifications of ISO 13741-1 standard. They are direct injection methods, so maximum use precautions must be taken with respect to the gas chromatograph so that false peaks do not occur.

Use of this technique provides suitable quality control, and in the field of research, it provides for developing techniques suitable for reducing residual monomer. Therefore, this technique has been a tool that has helped corroborate the production of dispersions that are lower in COVS, into which the residual monomer has been reduced.

The free monomer limits have been lowered to below 500 ppm by means of introducing redox reactions at the end of the polymerization.

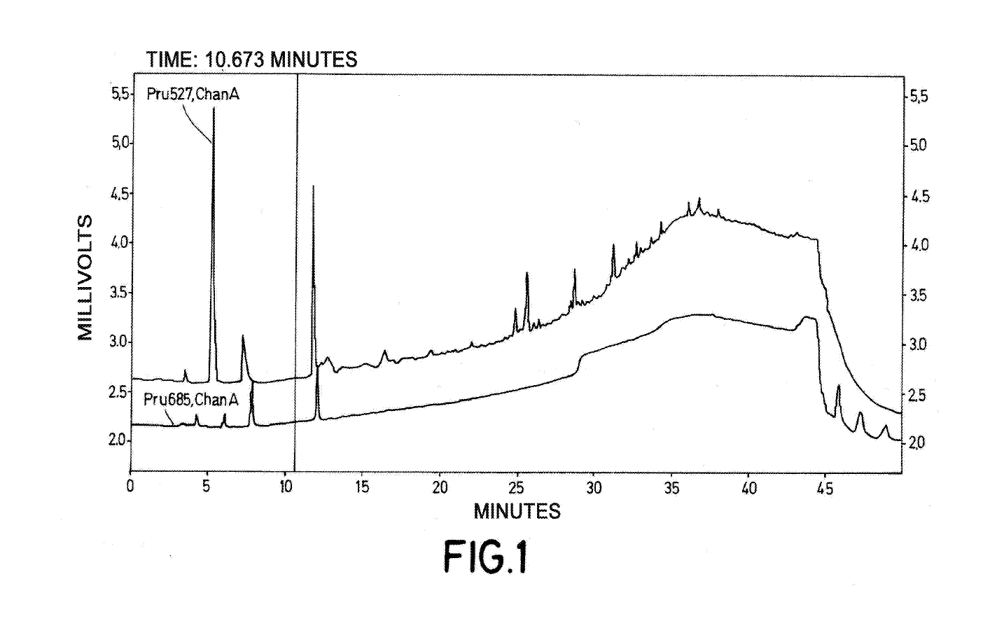

As can be seen in the graph of FIG. 1, there are two chromatograms. The chromatogram shown using the thin line corresponds to a sample of a conventional vinyl-VeoVa dispersion, with a lot of free monomer, in this case, vinyl acetate. The chromatogram shown using the thick line corresponds to the dispersion of the invention, having lower VOCs, because it contains a very small amount of vinyl acetate that has not reacted.

### Stability and Rheology

Stability tests were conducted by means of an Anton Paar MCR 501 rheometer with a cone-plate geometry having 40 cm in diameter and 1° angle. The temperature was kept constant at 25.0±0.1° C.

The first step consisted of determining the flow and viscosity curves of each of the samples.

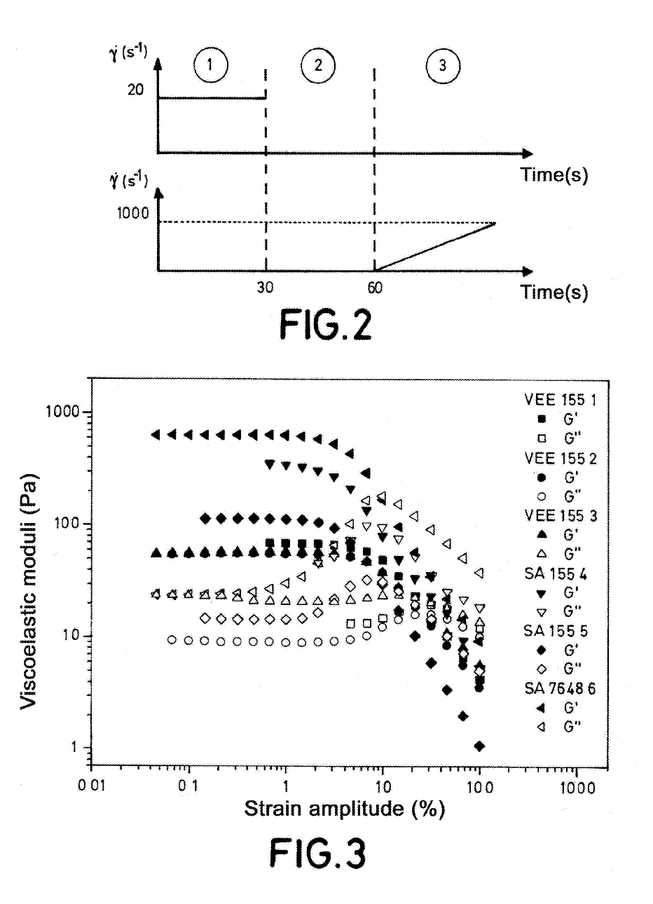

The following protocol was established to determine the viscosity of the samples (FIG. 2):
Pre-shearing at 20 s−1 for 30 s
Standing for 30 s
Testing

Pre-shearing allows homogenizing the sample while the standing period assures that the sample is relaxed prior to the measurement.

In all cases it is necessary to exceed a certain threshold stress to make the samples flow.

The Bingham model was fitted in the flow region to each of the curves for the purpose of quantifying the threshold stress:

τ=τ₀+ηₚ\dot{γ}

where τ₀ is the threshold stress and ηₚ plastic viscosity. In the case of paints, τ₀ must be greater than 1 Pa to thereby prevent pelleting during storage. When the threshold stress is known, it is possible to estimate film thickness in a vertical wall as this is proportional to the threshold stress; thickness α=τ₀/ρg can be estimated in a first approach. Finally, the plastic viscosity is associated with various paint application processes.

A fluidizing behavior is observed in the tests conducted because viscosity decreases as the strain rate increases. This behavior is characteristic of any plastic paint.

### Amplitude Sweep in Oscillation Mode

An estimation of the mechanical stability of the samples, which is often used in the paint research field, is determined from rheological tests in dynamic oscillation mode as a function of the strain to which the sample is subjected for a given constant frequency. In this case, a sinusoidal strain having increasing amplitude was applied at a constant frequency of 10 s−1. The resulting viscoelastic moduli of storage G′ and losses G″ are shown in FIG. 3.

As can be seen in said drawing, all the investigated samples have a similar behavior from a qualitative viewpoint. An initial, well-defined plateau up to strain amplitudes of at least 1% can be observed in all of them. For larger strain amplitudes, the storage modulus decreases.

The strain amplitude for which G′ dropped to 10% and is referred to as yield point and is directly associated with the mechanical stability of the material.

In the tests conducted on all the samples, a constant value is observed in the low-strain loss tangent consistent with the existence of a linear viscoelastic region. As amplitude increases, the loss tangent grows given that G″ increases and G′ decreases. The strain for which the loss tangent is equal to 1 (G′=G″) is referred to as flow point and is another indicator of the mechanical stability of the sample. It corresponds to the gel point where the energy stored is equal to the energy dissipated in each cycle.

According to the results, it can be concluded that the dispersion of modified VeoVa vinyl with the inclusion of active biocide ingredients has better stability properties than conventional dispersions.

### Testing in Paints

The produced dispersion containing active biocide ingredients and a conventional dispersion from the market were used for testing in paints. Several paints were made in a comparative manner with these two dispersions, in which the following properties were measured:
Viscosity measurements
Washability testing
Stability measurements
Whiteness and covering
Gloss measurements
Acceptance of the color when pigments are added
pH
Yellowing resistance
Scratch resistance
Weather resistance, etc.
Behavior in the different forms of application
Study of the behavior on the different surfaces for which the product is recommended
Results obtained after actual environmental exposures
Compatibility with the different components that are part of the formulation
Drying time

It could be seen in all the tests conducted that there were no significant differences between the dispersion considered to be the standard and the dispersion proposed in the present invention with the active biocide ingredients, so it is concluded that with this dispersion of modified VeoVa vinyl with active biocide ingredients, any type of plastic paint can be made for walls and ceilings/roofs for both indoors and outdoors.

Specifically, the features of the proposed dispersion are:

| Nature: | VeoVa vinyl | |
|---|---|---|
| % of solids: | 50 ± 1 | |
| Specific gravity: | 1.02 | g/cc |
| Tg: | 25 ± 1 | |
| MFFT: | 12 ± 1 | |
| Particle size: | 200 nm ± 20 | |
| pH: | 4.5 ± 0.5 | |
| Free monomer: | <500 | ppm |
| Brookfield viscosity: | 850 | ps |
| (Sp-4, 6 rpm, 20° C.,) | | |

Active biocide material content: 10%

Finally, specific examples of the emulsifier, biocide and catalyst elements preferably used, in addition to water, for a preferred embodiment of the proposed dispersion and the approximate percentage of those being the most essential, are described below:

### Monomers

| | |
|---|---|
| Vinyl acetate: | 38% |
| VeoVa-10: | 11% |

### Other Pre-Emulsion Components

Hydroxyethyl cellulose
Alkylaryl polyglycol ester sulfate, sodium salt
Alkylaryl polyglycol ether sulfate, sodium salt
Sodium bicarbonate
Alkylaryl polyglycol ether sulfate, sodium salt
Block copolymers of ethylene oxide and propylene oxide
Butyl acrylate
Vinyltrimethoxysilane

### Biocides

| | |
|---|---|
| Alpha-cypermethrin | 3.50% |
| D-allethrin | 6.50% |
| Pyriproxyfen | 0.30% |

### Catalysts

Sodium hydroxymethanesulfinate
Ammonium persulfate
Sodium metabisulfite

### Final Additions

TBHP-70
Sodium metabisulfite
Sodium bicarbonate
Preservative
Antifoaming agent

Having sufficiently described the nature of the present invention as well as the manner of putting it into practice, it is not considered necessary to further explain the invention so that a person skilled in the art may comprehend its scope and the advantages derived from it. It is hereby stated that, within its essential features, the present invention could be put into practice in other embodiments differing in detail from the embodiment indicated by way of example, and said other embodiments will also fall under the protection that is sought provided that the fundamental principle of the invention is neither altered, changed nor modified.

1. A binding dispersion for the production of insecticide paints, consisting of an aqueous dispersion of modified VeoVa vinyl, including active biocide materials such as alpha-cypermethrin, D-allethrin and pyriproxyfen, where the monomers making up the polymer forming the mass thereof are vinyl acetate and VeoVa, which further comprises as emulsifiers hydroxyethyl cellulose, alkylaryl polyglycol ester sulfate, sodium salt, alkylaryl polyglycol ether sulfate, sodium salt, sodium bicarbonate, block copolymers of ethylene oxide and propylene oxide, butyl acrylate and vinyltrimethoxysilane, and as catalysts it incorporates sodium hydroxymethanesulfinate, ammonium persulfate and sodium metabisulfite, characterized in that the active biocide materials it includes are immersed in the VeoVa vinyl polymer mass, such that said active materials surround the polymer particles forming a core-shell type structure, i.e., polymer core and shell of active ingredients.

2. The binding dispersion for the production of insecticide paints according to claim 1, characterized in that said biocides are incorporated in the following percentage proportions:

| | |
|---|---|
| Alpha-cypermethrin | 3.50 |
| D-allethrin | 6.50 |
| Pyriproxyfen | 0.30 |

3. The binding dispersion for the production of insecticide paints according to any of claims 1 and 2, characterized in that the vinyl acetate and VeoVa-10 are incorporated in the following percentage proportions:

| | |
|---|---|
| Vinyl acetate | 37.77 |
| VeoVa-10 | 10.93 |

4. The binding dispersion for the production of insecticide paints according to any of claims 1-3, characterized in that in addition to preservative and antifoaming agents, it also incorporates the following elements as final additions:
TBHP-70
Sodium metabisulfite
Sodium bicarbonate

5. A method for producing a binding dispersion for the production of insecticide paints according to that described in any of claims 1-4, characterized in that it comprises the following steps:
seeding step, where a small part of the pre-emulsion (mixture of monomers, emulsifiers, water) with a small amount of catalyst is added to the reactor to achieve the formation of polymer cores with very similar particle sizes;
reaction or polymerization step per se, where the rest of the catalyst and pre-emulsion are added simultaneously so that they may react; the active biocide materials are added when this step concludes;
once the additions have ended, it is left to stir at high temperatures for at least one hour so that the monomer that may remain from the preceding step finishes reacting;
when the preceding step concludes, a redox reaction is performed, in which a reducing agent and an oxidizing agent are added, and when these agents react they cause using up also the rest of the monomers that have not yet reacted.
